(19) United States
(12) Patent Application Publication
(10) Pub. No.: US 2010/0316919 A1
(43) Pub. Date: Dec. 16, 2010

(54) FUEL CELL STACK WITH HEAT RECUPERATOR

(75) Inventors: Nathan Ernst, Ann Arbor, MI (US); Paul Jawlik, Ann Arbor, MI (US); Aaron T. Crumm, Ann Arbor, MI (US); Tim LaBreche, Ann Arbor, MI (US); Nicholas Schoeps, Ann Arbor, MI (US)

Correspondence Address: Adaptive Materials Inc., 5500 S. State Rd., Ann Arbor, MI, 48108, US

(73) Assignee: ADAPTIVE MATERIALS, INC., Ann Arbor, MI (US)

(21) Appl. No.: 12/484,264

(22) Filed: Jun. 15, 2009

(51) Int. Cl. H01M 8/04; H01M 8/18; B23K 31/02; B23K 9/00

(52) U.S. Cl. 429/423; 228/170; 219/137 R; 429/452; 429/535; 429/439

(57) ABSTRACT

A fuel cell stack includes a plurality of solid oxide fuel cell tubes and a heat recuperator. The heat recuperator is formed from sheet metal. The plurality of walls define an exhaust gas channel having an exhaust gas flowing therethrough and an oxidant channel having an oxidant flowing therethrough. The exhaust gas channel is in thermal communication with the oxidant channel such that heat is transferred between the exhaust gas and the oxidant.

### GOVERNMENT INTERESTS

This invention was made with government support under contract number W909MY-08-C-0025, awarded by the Department of Defense. The government has certain rights in this invention.

### BACKGROUND

The statements in this section merely provide background information related to the present disclosure and may not constitute prior art.

Solid oxide fuel cells react air and fuel at opposite electrodes of an electrochemical cell to generate electricity. Solid oxide fuel cells have been shown to be extremely efficient in terms of fuel efficiency, energy-to-volume ratio, and energy-to-weight ratio when compared to current portable power systems. Due to these efficiencies, solid oxide fuel cells have been developed for use in portable power systems. However, solid oxide fuel cells are not currently utilized in a wide range of portable power application due, in part, to obstacles related to heat management within solid oxide fuel cell stacks.

Efficient and low-cost heat management systems are highly desirable in solid oxide fuel cell systems. For example, solid oxide fuel cell systems are controlled to setpoint temperatures within the range of, for example, 650 degrees Celsius to 950 degrees Celsius. When the solid oxide fuel cell systems deviate from the setpoint temperature, the solid oxide fuel cell systems can have undesired performance and lifetime losses. Further, solid oxide fuel cell systems can carry a raw fuel onboard and can include an internal reformer for converting the raw fuel to a reformed fuel, wherein the reformed fuel can be utilized to generate electromotive force within the electrochemical cell. The onboard reformer can partially oxidize raw fuel through catalytic reactions. Heat must be properly managed within the fuel cell system to maintain the onboard reformer within a desired temperature range such that sufficient heat is available to facilitate appropriate partial oxidization reactions at desired reaction rates while controlling reformed fuel to desired temperatures for reacting with a fuel cell downstream the onboard reformer.

To efficiently conserve energy within the fuel cell system, heat can be transferred between exhaust gases and incoming gases within the fuel cell system. However, due to the high operating temperatures and the heat management requirements of the solid oxide fuel cell system, traditional heat exchangers have very high costs and are ineffective in managing heat within portable solid oxide fuel cell systems.

Therefore, there is a need for a solid fuel cell system that can efficiently manage heat utilizing a low cost heat management system to overcome challenges for solid oxide fuel cell systems utilized in portable power applications.

### SUMMARY

In accordance with an exemplary embodiment, a solid oxide fuel cell stack includes a plurality of solid oxide fuel cell tubes and a heat recuperator. Each solid oxide fuel cell tube is configured to receive a fuel gas at a first end and discharge an exhaust gas at a second end. The heat recuperator includes a plurality of walls connected by welded joints. The plurality of walls are formed from sheet metal and define an exhaust gas channel having an exhaust gas flowing therethrough and an oxidant channel having an oxidant flowing therethrough. The exhaust gas channel is in thermal communication with the oxidant channel such that heat is transferred between the exhaust gas and the oxidant.

In accordance with another exemplary embodiment, a heat reformer is manufactured by first cutting heat reformer preforms from sheet metal. The heat reformer preforms are bent to heat recuperator component shapes. The heat recuperator component shapes are welded to form heat recuperator components. The heat recuperator components are welded to form the heat recuperator.

### BRIEF DESCRIPTION OF DRAWINGS

One or more embodiments will now be described, by way of example, with reference to the accompanying drawings, in which:

FIGS. 1 and 2 depict prospective cutaway views of a fuel cell stack including a heat recuperator in accordance with an exemplary embodiment of the present disclosure;

FIGS. 3 and 4 depict prospective views of the heat recuperator of FIG. 1;

FIGS. 5A and 5B depict cutaway prospective view of the heat recuperator of FIG. 1; and

FIGS. 6A and 6B depict pre-forms of the heat recuperator of FIG. 1;

It should be understood that the appended drawings are not necessarily to scale, presenting a somewhat simplified representation of various preferred features illustrative of the basic principles of the invention. The specific design features of the solid fuel cell as disclosed here, including, for example, specific dimensions will be determined in part by the particular intended application and use environment. Certain features of the illustrated embodiments have been enlarged or distorted relative to others for visualization and clear understanding. In particular, thin features may be thickened, for example, for clarity of illustration.

### DETAILED DESCRIPTION

At the outset of the detailed description, it should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Further, such orientation terms such as top, bottom, inner and outer are used herein to describe relative locations of system components of exemplary embodiments with respect to each other. However, it is to be recognized that other terms of orientation may be utilized when different reference points are given. Further, it is contemplated that in alternative embodiments, system components can have other orientations relative to each other without deviating from the scope of the invention.

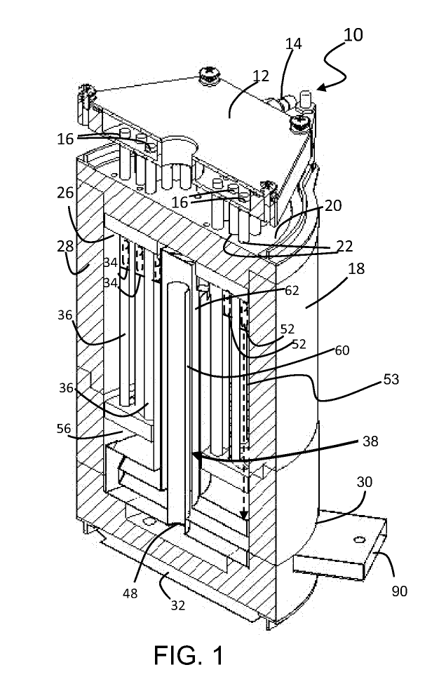

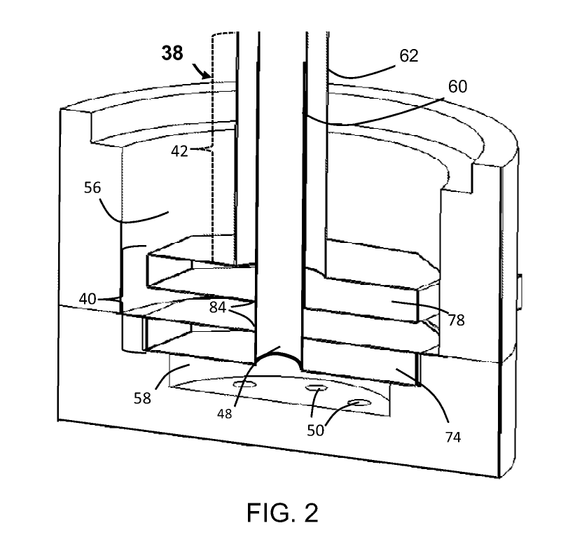

Referring now to the drawings, wherein the showings are for the purpose of illustrating certain exemplary embodiments only and not for the purpose of limiting the same, FIGS. 1 and 2 are cutaway prospective view of a solid oxide fuel cell stack 10. The solid oxide fuel cell stack 10 includes a manifold 12, an insulated body 18 and fuel feed tubes 34 disposed within both the manifold 12 and the insulated body 18. The manifold 12 is secured to the insulated body 18 utilizing structural support members (not shown). The manifold 12 includes a manifold inlet 14 configured to receive an air/fuel mixture and a plurality of manifold outlet openings 16 each configured to receive one of the fuel feed tubes 34. The exemplary fuel feed tubes 34 can comprise for example, at least one of zirconia, alumina, and a metal alloy and each of the exemplary fuel feed tubes 34 are sealed to the manifold 12 such that the air/fuel mixture provided manifold inlet can be distributed to each of the fuel feed tubes 34. In one embodiment, a silicon-based adhesive is utilized to secure the fuel feed tubes 34 to the manifold 12.

The insulated body 18 includes an insulated cap member 20 and insulated body walls 28, which together define an insulated body chamber 26. The insulated body cap member 20 comprises a material generally robust in the operating environment of the fuel cell stack 10. The insulated body cap member includes a plurality of openings 22 disposed therethrough. Each of the openings 22 is configured to receive one of the fuel feed tubes 34, therethrough.

The insulated body walls 28 include an air opening 30 and an exhaust opening 32. The insulated body walls 28 are capable of maintaining high temperatures within the insulated body chamber 26 and are generally robust in the operating environment of the fuel cell stack 10. For exemplary insulated body material, see U.S. patent application Ser. No. 11/670,554 to Crumm et al entitled “Composite Insulation Assembly for a Fuel Cell,” which is hereby incorporate by reference herein.

The insulated body further includes a plurality of onboard fuel reformers 52 a plurality of fuel cell tubes 36, and a heat recuperator 38 each disposed therein.

The onboard fuel reformers 52 are provided to partially oxidize a raw fuel to a reformed fuel such that the reformed fuel can be utilized by the fuel cell tubes 36 to generate electricity and such that the reformed fuel can transfer sufficient heat generated by the reformation reactions to an active area of the fuel cell tubes to heat the active area to a desired operating temperature. The raw fuel can comprise a wide range of hydrocarbon fuels, including, for example, butane, propane, gasoline, diesel fuel, and JP-8 fuel, along with other hydrocarbon fuels. The reformed fuel can be utilized in electrochemical reactions at the anode of the fuel cell tubes and can include one or more partially oxidized fuels, such as hydrogen, carbon dioxide, carbon monoxide, and water.

The onboard fuel reformers 52 comprise a metallic catalyst material such as platinum disposed on a ceramic substrate such as an alumina or a zirconia substrate. One of the onboard fuel reformers 52 is disposed within each of the fuel feed tubes 36 at an end proximate to an active area of each of the fuel cell tubes 36. Thus, the fuel feed tubes thermally isolates the onboard fuel reformer 52 from the anode of the fuel cell tube 36, which is advantageous in that when fuel passes through the catalytic substrate, significant heat is generated and the thermally isolating barrier reduces heat induced stresses on the fuel cell tubes. Although the exemplary material sets are described for the fuel feed tubes 36 and the onboard fuel reformers 52, other compositions will be readily apparent to those skilled in the art such as other ceramic materials or other metal materials capable of the operating characteristics described above.

The fuel cell tubes 36 each comprise an anode layer disposed on an inside of the fuel cell tube 36, an electrolyte layer, and a cathode layer disposed on an outside of the fuel cell tube 36 at the active portion, which is the portion of the fuel cell tubes that generates electromotive force at operating temperatures in the range of 650 to 950 degrees Celsius. However, only the active portion of the fuel cell tube contains the anode layer, the electrolyte layer, and the cathode layer, and therefore, only a portion of the fuel cell tube requires high operating temperatures for generating electromotive force. The fuel cell tubes further include inner and outer electrode current collecting members (not shown) and interconnect members (not shown) for collecting current generated at the fuel cell tubes 36 and for routing the current from the fuel cell stack 10 such that the current can be utilized by electrical devices (not shown).

During operation, reformed fuel reacts at an anode layer and oxygen reacts at a cathode layer, thereby generating an electromotive force. Fuel that is unutilized within the fuel cell tubes is routed out of the fuel cell tubes 36 in a cell exhaust path into a flame region 56. When the unutilized fuel sufficiently mixes with oxygen within the flame region 56, the unutilized fuel is combusted thereby heating the flame region to temperatures within the range of 800 to 1,200 degrees Celsius. The cell exhaust path of the heated exhaust gas travels in a general direction that intersects a planar portion 40 of the heat recuperator 38.

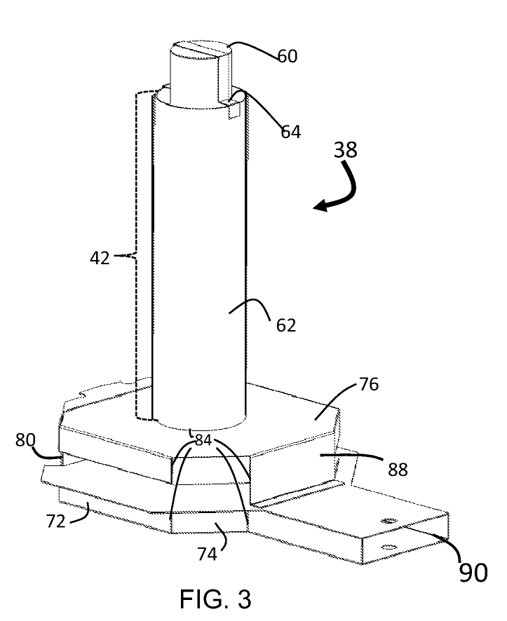

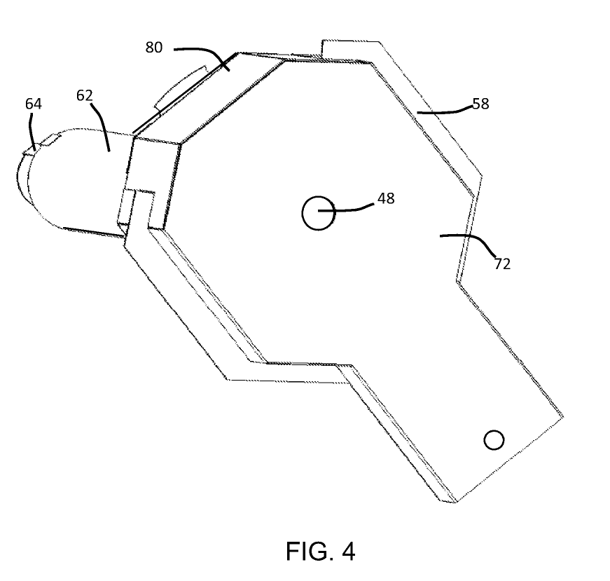

FIGS. 1 and 2 depict the heat recuperator 38 in relation to other components of the fuel cell stack 10, and FIGS. 3-5 depict other views of the heat recuperator 38. The heat recuperator 38 is provided to retain heat within the fuel cell stack 10 by transferring heat between a fuel cell exhaust stream and an incoming fuel cell oxidant stream. The fuel cell exhaust comprises reaction products which are routed out the insulated body chamber. The exemplary oxidant stream comprises atmospheric air, which includes oxygen that is provided to electrochemically react at the cathode layers of the fuel cell tubes 36. Although the oxidant that reacts with the cathode will referred to as “air” throughout this application, in other exemplary embodiments, other oxidants such as substantially pure oxygen gas may be utilized within the fuel cell stack 10.

The heat recuperator 38 includes the planar portion 40 and a tubular portion 42. The planar portion 40 includes a collar 58, first stage walls 72, second stage walls 76, stage connecting walls 80, and a structural member 88, wherein the various walls 72, 76, 80 and the structural member 88 are formed through bending sheet metal and are coupled through sealed weld joints 84. The first stage walls 72 define an air inlet conduit 90 and a first air chamber 74. The second stage walls 76 define a second air chamber 78. The first stage walls 72 are configured to extend through the insulated body air opening 30 of insulated body walls 48 to allow an air supply tube (not shown) to connect to the air chamber 74 of the heat recuperator 38. The stage connecting walls 80 define a stage connecting conduit 82. An exhaust flow stage 92 is defined by a top wall of the first stage walls 72, a bottom wall of the second stage walls 76, an inner wall of the stage connecting walls, and the structural member 88.

The tubular portion 42 provides single pass co-directional flow path heat exchange between incoming air and both exhaust gas within the heat recuperator 10 and fluid outside the heat recuperator 10, but within the insulated body chamber 26. Further, the tubular portion 42 provides incoming air in heat exchange contact with the fluid within the insulated body chamber such that the incoming air is temperature can equilibrate with the fluid within the insulated body chamber. The tubular portion 42 includes inner tube walls 60, shell walls 62, and outer tube walls 64. The inner tube walls 60 are disposed through openings in the first stage walls 72 and second stages 76 of the heat recuperator 38 and are connected to a bottom wall of the first stage walls 72, wherein welded joints 84 couple and seal the inner tube walls to the bottom wall of the first stage walls 72. The shell walls 62 are disposed through an opening in a top wall of the second stage walls 76 and are connected to a bottom wall of the second stage walls 76, wherein one of the welded joints 84 couples and seals the inner tube walls to the bottom wall of the second stage wall 76.

The shell walls 62 are disposed through an opening in a top wall of the second stage walls 76 and are connected to a bottom wall of the first stage walls 74, wherein one of the welded joints 84 couples and seals the shell walls 62 to the bottom wall of the second stage walls 76. The outer tube walls 64 are connected to a top wall of the second stage walls 74, wherein one of the welded joints 84 couples and seals the outer tube walls 64 to the top wall of the second stage walls 76.

The inside portions of the inner tube walls 60 define a second exhaust conduit 61. The outside portions of the inner tube wall 60 and the inner portions of the shell wall 62 define a first exhaust conduit 63. The outer portions of the shell wall 62 and the inner portions of the outer tube walls 64 define an air conduit 65.

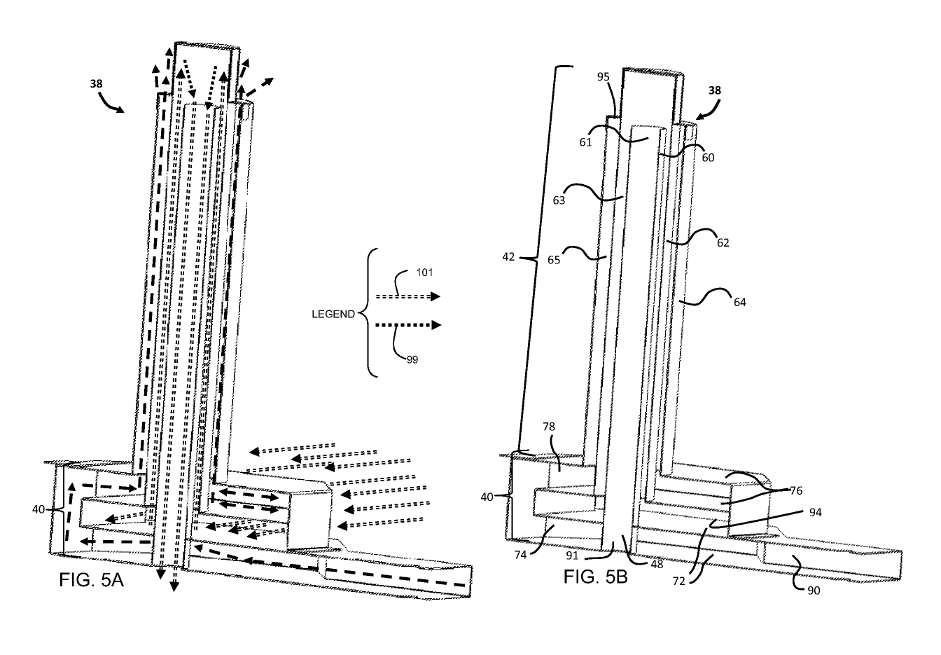

During operation, an atmospheric air flow stream (represented by single dashed lines 99 in FIG. 5A) passes through an air channel within the heat reformer 38 from the air inlet conduit 90 to an air outlet 95. In particular, the atmospheric air enters the air inlet conduit 90 and is routed downstream through the first air chamber 74, the second air chamber 78, and the air conduit 65. The air exits through an air outlet opening 95 in and is diffused such that air is dissipated throughout the insulated body chamber 27 and can react with the entire cathode surface of the each fuel cell tube 36. The exhaust gas flow stream (represented by two parallel dashed lines 101) passes through an exhaust channel 105 within the heat reformer 38 from an exhaust inlet opening 94 to an exhaust outlet opening 91. In particular, the exhaust enters the exhaust inlet opening 94 is routed into the exhaust stage 92, through the first exhaust conduit 63, then through the second exhaust conduit 61 and out through an exhaust outlet opening 91. The exhaust gas is routed through an exhaust gas holding chamber 58 (FIG. 2) and through a plurality of openings 59 (FIG. 2) within the insulated body 18, wherein the exhaust gas is then routed out of the fuel cell stack 10.

Heat is transferred between the exhaust gas flow stream 101 in the exhaust stage 92 and the air flow stream 99 in the first air chamber 74 and the second air chamber 78 primarily through convective heat transfer from the fluid to the walls 72 and 76. The exhaust flow stream 101 flows substantially perpendicular to the air flow stream 99 within the planar portion 40 of the heat recuperator 38.

Further, heat is transferred between the air flow stream 99 in the second air chamber 78 and fluid disposed within the exhaust holding chamber 58 and within the insulated body chamber 26 outside the heat recuperator 38 through top and side walls of the second stage walls 76. Further, heat is transferred between the air flow stream 99 in the air flow conduit 65 and the exhaust gas flow stream in the second exhaust conduit 63 through the shell walls 62, wherein the exhaust flow stream 101 flows in substantially the same flow direction as the air flow stream 99. Heat is also transferred between the air flow stream in the air flow conduit 65 and fluid disposed in the insulated body chamber 26. Still further, heat can be transferred between the exhaust gas flow stream in the second exhaust conduit 63 and the exhaust gas flow stream in the first exhaust conduit 61 through the inner tube wall 60.

Since the air outlet opening 95 is disposed at an opposite end of the insulate body chamber than the exhaust inlet opening 94 of the fuel reformer 36, fuel is allowed to dissipate throughout the insulated body chamber 26 thereby allowing air to react over substantially the entire surface area of the cathode layers of the fuel cell tubes 36.

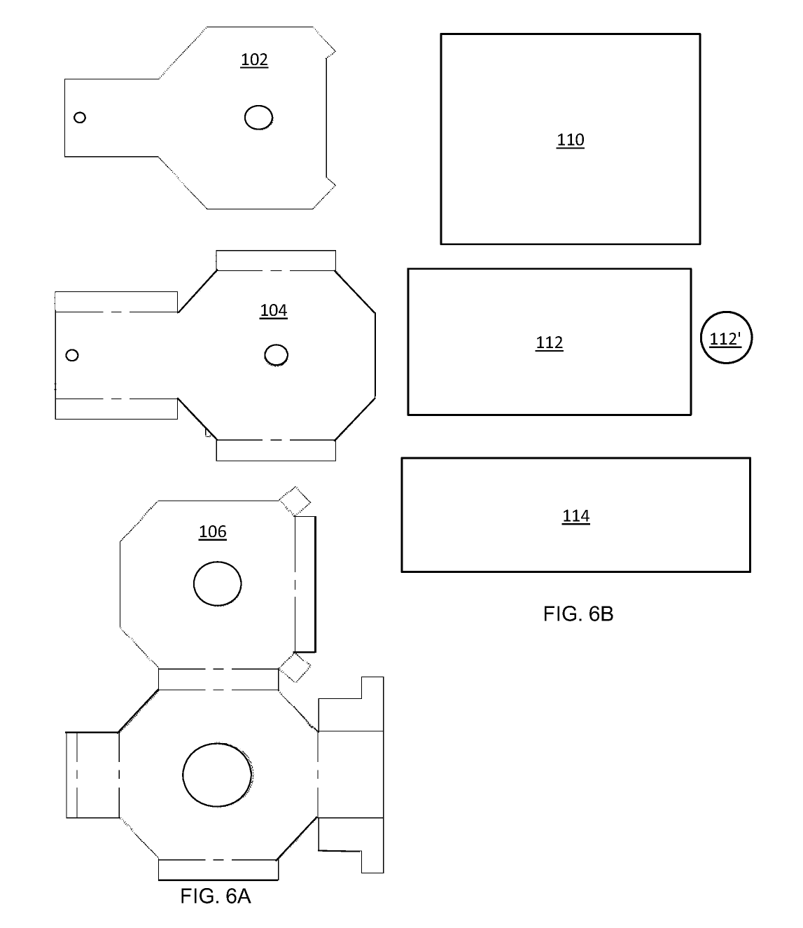

FIG. 6A shows component preforms 102, 104, and 106 of the planar portion 40 of the heat recuperator 38 and FIG. 5B shows component preforms 110, 112, and 114 of the tubular portion 42. FIG. 5A depicts the preforms of the planar portion of the heat exchanger. The preforms 102, 104, 106, 110, 112, 112′ and 114 are generally shown with dashed lines indicating areas where the preforms can be bent and curved to provide desired shapes to the components. The heat reformer is manufactured by first cutting the preforms 102, 104, 106, 110, 112, and 114 from sheet metal. The preforms are then bent to heat recuperator component shapes. The heat recuperator component shapes are then welded to form heat recuperator components. The heat recuperator components are welded to form the heat recuperator having gas tight seals to provide the air channel 103 and the exhaust channel 105.

Once the preforms are formed to the desired shapes, walls of the preforms are joined by welding thereby forming the stage member 70 along with the first air chamber 74 and the second air chamber 76.

In an exemplary embodiment the heat recuperator comprises a metal that can be formed to the desired shapes and is generally compatible with the high operating temperatures of the insulated body chamber 26 of the fuel cell stack 10. In an exemplary embodiment, the heat exchanger comprises a high-temperature alloy comprising at least one of nickel and chromium. Further, exemplary materials for the heat recuperator 38 can include austenitic nickel-chromium-based superalloys sold under the Inconnel trademark by Specialty Metals corporation. In alternate embodiments, other materials such as other nickel, chromium, and iron based alloys can be utilized.

The heat recuperator has a low pressure drop between inlet opening and outlet openings. Therefore, small-sized, low-power, air and fuel air motivating device (e.g., pumps and blowers) can be utilized to move air and fuel through the fuel cell stack 10. Further, the low pressure drop across the heat recuperator allows low cost composite silicon insulation to insulate the fuel cell stack to maintain low internal stack pressures. Further, low-cost welding methods can be utilized to join portions of the heat recuperator. The exemplary heat recuperator can be resistance welded. In other embodiments, the recuperator can be welded by other welding processes and can be welded utilizing intermediate braze materials. In an alternate embodiment, the heat recuperator can be arc welded.

The fuel cell stack 10 including the heat recuperator 38 has several advantageous features over other fuel cell stacks. The heat recuperator 38 is very low cost in that it utilizes relatively cheap sheet metal components, has a low material weight and is easily to mass manufacture through bending and welding the components. In an exemplary embodiment, substantially the entire heat recuperator 38 is made with a single metal material thereby reducing costs. Further, the heat exchanger is robust in the operating environment of the insulated body chamber 26 the heat exchanger and is designed with several features to optimize heat exchange between the exhaust fluid stream and the air stream. Still further, the heat exchanger is compact and light weight such that it can be utilized for portable solid oxide fuel cell applications.

1. A solid oxide fuel cell stack comprising:
a plurality of solid oxide fuel cell tubes, each solid oxide tube being configured to receive a fuel gas at a first end and discharge an exhaust gas at a second end, and
a heat recuperator comprising a plurality of walls connected by welded joints, the plurality of walls being formed from sheet metal, the plurality of walls defining an exhaust gas channel having an exhaust gas flowing therethrough and an oxidant channel having an oxidant flowing therethrough, the exhaust gas channel being in thermal communication with the oxidant channel such that heat is transferred between the exhaust gas and the oxidant.

2. The fuel cell stack of claim 1, wherein the heat recuperator walls comprise a metal alloy comprising at least one of chromium and nickel.

3. The fuel cell stack of claim 1, wherein the heat recuperator comprises a tubular portion and a planar portion.

4. The solid oxide fuel cell of claim 3, wherein the tubular portion of the heat recuperator includes shell walls and tube walls.

5. The solid oxide fuel cell of claim 3, wherein walls of the tubular portion of the heat recuperator are formed of curved sheet metal joined by a welded joint.

6. The fuel cell stack of claim 3, wherein the solid oxide fuel cell tubes are configured to route exhaust gases in an exhaust path and wherein the planar portion of the heat recuperator intersects the cell exhaust path.

7. The fuel cell stack of claim 1, wherein heat is transferred between the exhaust gas and the oxidant when the exhaust gas and the oxidant are flowing in co-directional flow paths to each other.

8. The fuel cell stack of claim 1, wherein heat is transferred between the exhaust gas and the oxidant when the exhaust gas and the oxidant are flowing in counter-directional flow paths to each other.

9. The fuel cell stack of claim 1, wherein heat is transferred through a heat recuperator wall between the exhaust gas in a first portion of the exhaust gas channel and exhaust gas in a second portion of the exhaust gas channel.

10. The fuel cell stack of claim 1, wherein the welded joints and the plurality of walls of the heat recuperator comprise substantially similar materials.

11. The fuel cell stack of claim 1, wherein the welded joints are resistance welded joints.

12. The fuel cell stack of claim 1, wherein the oxidant is air.

13. The fuel cell stack of claim 1, further comprising an onboard reformer configured to convert a raw fuel to a reformed fuel.

14. The fuel cell stack of claim 13, wherein the onboard reformer comprises internal reformers within the fuel cell tubes.

15. A solid oxide fuel cell stack, comprising:
a plurality of solid oxide fuel cell tubes, each solid oxide fuel cell tube being configured to receive a fuel gas within a first end and discharge an exhaust gas at a second end;
a heat recuperator comprising a plurality of walls, the walls comprising an alloy including at least one chromium and nickel, the plurality of walls being connecting by welded joints, the plurality of walls comprising sheet metal, the plurality of walls defining an exhaust gas channel having an exhaust gas flowing therethrough and an oxidant channel having an oxidant flowing therethrough, the exhaust gas channel being in thermal communication with the oxidant channel such that heat is transferred between the exhaust gas and the oxidant; and
an onboard reformer configured to convert a raw fuel to a reformed fuel.

16. The fuel cell stack of claim 15, wherein the heat recuperator comprises a tubular portion and a planar portion.

17. The fuel cell stack of claim 15, wherein the solid oxide fuel cell tubes are configured to route exhaust gases in an exhaust path and wherein the planar portion of the heat recuperator intersects the exhaust path.

18. A method for manufacturing a heat recuperator comprising:
cutting heat recuperator component preforms from sheet metal;
bending the preforms to heat recuperator component shapes;
welding walls of heat recuperator component shapes to form heat recuperator components; and
joining the heat recuperator components utilizing welding to form the heat recuperator.

19. The method of claim 18, further comprising positioning the heat recuperator in a solid oxide fuel cell stack.

20. The method of claim 18, further comprising arc welding walls of heat recuperator components shapes and joining the heat recuperator components utilizing arc welding.
